(19) United States
(12) Patent Application Publication
(10) Pub. No.: US 2004/0063494 A1
(43) Pub. Date: Apr. 1, 2004

(54) Prepaid gaming card method

(76) Inventors: Scott Oram, El Cajon, CA (US); Robert Oram, El Cajon, CA (US)

Correspondence Address: Scott Oram, 9649 Palomino Ridge Dr., El Cajon, CA, 92021, US

(21) Appl. No.: 10/260,176

(22) Filed: Sep. 27, 2002

(51) Int. Cl. A63F 13/00

(52) U.S. Cl. 463/42

(57) ABSTRACT

Methods for distributing, activating, and using prepaid gaming cards are presented. The prepaid gaming cards are made available to consumers in various locations including retail outlets, department stores, financial institutions, and other convenient places. Consumers purchase a prepaid gaming card in a desired denomination and then activate the card. The card can be activated over the phone, at a special kiosk, or via the web. Once the card has been activated, the consumer can use the card to access gaming web sites and pay for gaming entertainment provided by private companies and state or federal gaming authorities. The amount available on the card may increase or decrease depending on the success of the consumer, and the value of the card may be distributed back to the consumer via an electronic transfer or a cash distribution at a retail location. When the value of the card is depleted, the card can be refilled with additional funds.

### BACKGROUND

1. Field of the Invention

The present invention generally relates to the gaming industry and more particularly relates to prepaid gaming cards and methods of using prepaid gaming cards.

2. Related Art

Internet gambling is an industry that is gaining momentum in the United States. There has been much legislative discussion surrounding this industry, most of which include attempts at banning on-line gambling or regulating it. Certain states, namely Nevada, are moving forward with draft legislation that will make network based gambling legal and also provide a regulatory framework. Similarly, the United States Virgin Islands has proposed legislation that would legalize network based gambling and lotteries New Jersey also has pending legislation that would allow Atlantic City casinos offer network based gaming. The network based gaming industry is potentially huge, with projections of reaching the $10 billion mark by the year 2005.

Because there is the potential for network based gaming to be made illegal through federal or state legislation, there are few conventional network based gaming platforms to serve this industry. Therefore, network based gaming solutions are needed to facilitate this growing industry.

### SUMMARY

The prepaid gaming card process allows a consumer to purchase a gaming card in a predetermined denomination. A gaming card may be purchased at a retail distribution store, at a federal or state authorized gaming outlet, or over the Internet. The consumer can then activate the card by accessing a network based gaming web site. When visiting the network based gaming web site, the consumer provides a personal identification number (“PIN”) obtained from the prepaid gaming card packaging or the card itself. This PIN is provided to a central server that authenticates and activates the gaming card. Once the card has been activated, it can be used for playing network based games on any authorized web site that offers that types of entertainment.

Once the initial value of the card has been depleted, the card can be refilled with additional funds through a subsequent activation process, which can be carried out over the telephone, at a special kiosk, or over the internet.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a front view of an example prepaid gaming card according to an embodiment of the present invention;

FIG. 2 is a back, view of an example prepaid gaming card according to an embodiment of the present invention;

FIG. 3 is a high level network diagram illustrating an example gaming network according to an embodiment of the present invention;

FIG. 4 is a flow diagram illustrating an example process for using a prepaid gaming card according to an embodiment of the present invention;

FIG. 5 is a flow diagram illustrating an example process for activating a prepaid gaming card according to an embodiment of the present invention; and

FIG. 6 is a flow diagram illustrating an example process for cashing out a prepaid gaming card according to an embodiment of the present invention.

### DETAILED DESCRIPTION

Certain embodiments as disclosed herein provide for prepaid gaming card processes. For example, one method as disclosed herein allows a consumer to purchase a prepaid gaming card in a desired denomination and then use that card to access gaming oriented websites and pay for gaming oriented entertainment after the card has been activated.

After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention as set forth in the appended claims.

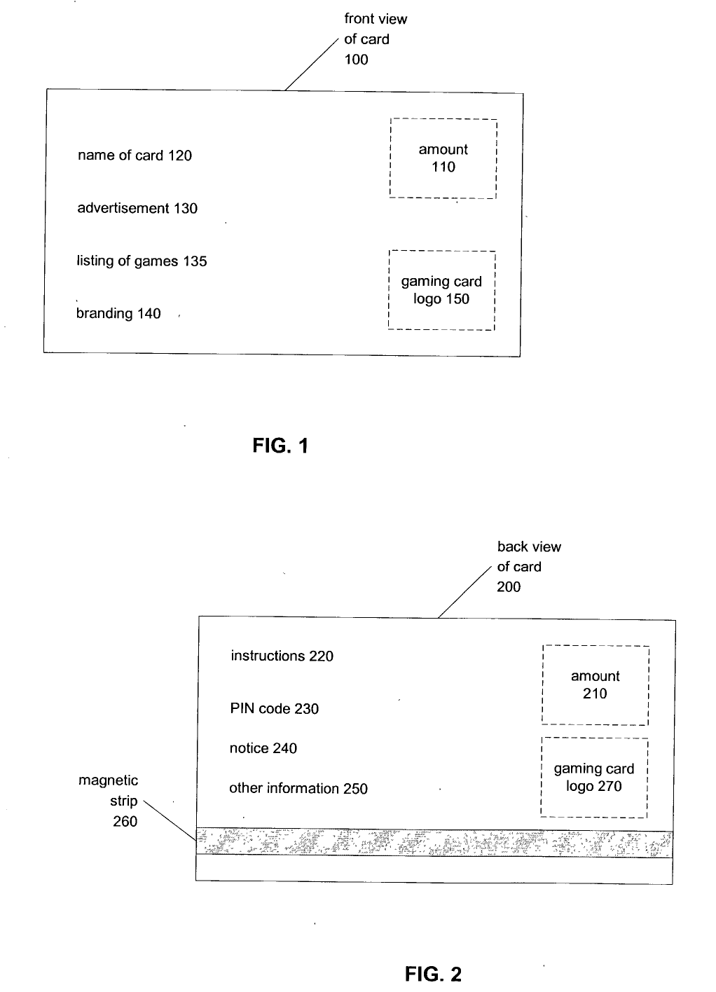

FIG. 1 is a front view of an example prepaid gaming card 100 according to an embodiment of the present invention. In the illustrated embodiment, there are several discrete areas or regions on the front of the card that are used to present different types of information. First, the amount 110 of the card is presented in the upper right hand corner. It should be noted at this point that the various discrete regions can be placed at locations on the card other than those places identified in the illustrated embodiment. The function of the discrete regions is to provide information. That being stated, there can be more or less regions presented on the front of the card in order to effectively and efficiently provide information to the consuming public.

Also presented on the front of the card 100 is the name of the card 120, an advertisement 130, a listing of games 135, and branding 140. Additionally, a gaming card logo 150 can be displayed on the front of the card 100. Advantageously, the name of the card 120 allows different companies or state gaming authorities to market their own services through the use of the card. For example, a casino or a state lottery might place their logo or trademark here. The advertisement 130 region can be used for any type of advertisement, the listing of games 135 can be printed on the card in text or iconic format or embossed into the material of the card, and the branding 140 region is preferably used to display the brand of the overall maker and provider of the prepaid gaming card, such as Pay$World™.

FIG. 2 is a back view of an example prepaid gaming card 200 according to an embodiment of the present invention. In the illustrated embodiment, there are several discrete areas or regions on the back of the card that are used to present different types of information. First, the amount 210 of the card is presented in the upper right hand corner. It should be noted at this point that the various discrete regions can be placed at locations on the back of the card other than those places identified in the illustrated embodiment. The function of the discrete regions is to provide information. That being stated, there can also be more or less regions presented on the back of the card in order to effectively and efficiently provide information to the consuming public.

In the illustrated embodiment, the back of the card 200 also includes instructions 220 and the PIN code 230. These two pieces of information advantageously provide a consumer with all of the information needed to activate the card and perhaps even to access a gaming web site. For example, the instructions may include a telephone number that the consumer can call in order to activate the card or a web site where the consumer can activate the card. During the activation process, the consumer is asked to provide the PIN code from PIN code region 230. The PIN code region 230 may also advantageously contain a barcode that can be read by a bar code reader device.

In addition, the back of the card 200 in the illustrated embodiment contains a notice 240 region and an other information 250 region. These regions 240 and 250 can be used to provide legal notices and other types of information to the consuming public. For example, the legal ramifications of activation and use of the gaming card may be provided along with certain intellectual property information.

The illustrated embodiment also includes a magnetic strip 260 on the back of the card 200. The magnetic strip 260 advantageously is configured to store information pertaining to the prepaid gaming card. For example, the magnetic strip may be preprogrammed with a unique card number, the PIN code, and the denomination or amount of the card.

Finally, the illustrated embodiment includes a gaming card logo 270 that may include the same logo that is presented on the front of the card. Alternatively, the logo 270 may contain an alternative logo or co-branding information, logos, or trademarks.

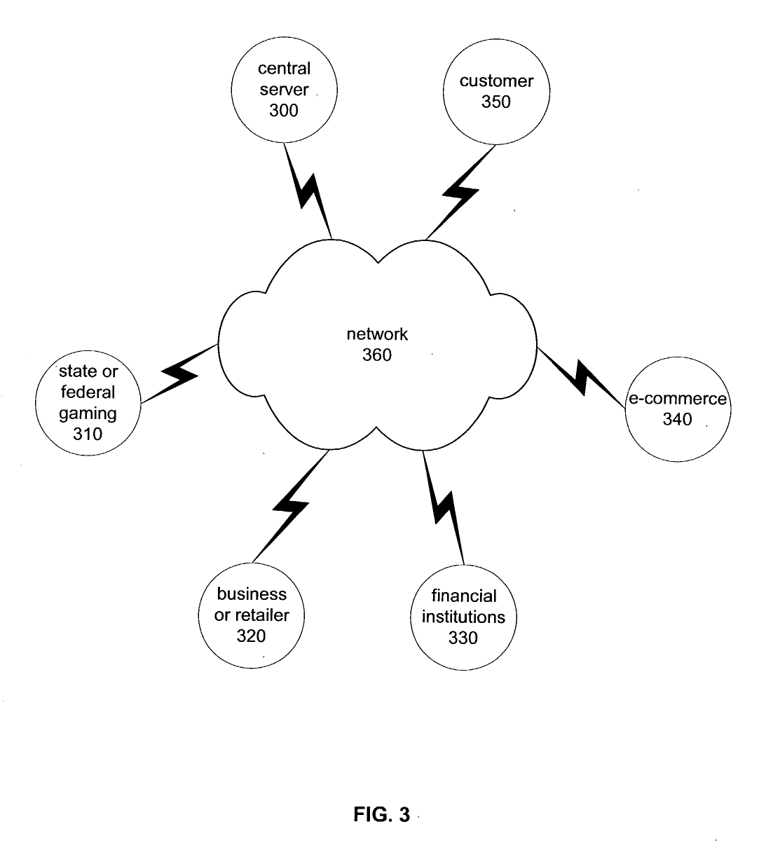

FIG. 3 is a high level network diagram illustrating an example gaming network 360 according to an embodiment of the present invention. The gaming network 360 preferably links up a variety of gaming sites 310 with a central server 300. Additionally, the gaming network 360 preferably links up additional providers such as businesses or retailers 320 that may sell the gaming cards, e-commerce web sites 340 that may sell the gaming cards, consumers 350, and financial institutions 330 that may validate financial transactions or receive distributions.

The network 360 can be any type of communication network including wired and wireless networks or combinations thereof. For example, network 360 may include the Internet and also the financial ACH network or EFT networks for moving funds. In addition, network 360 may also include a wireless communication network whereby consumers 350 access the various gaming sites 310 via a mobile communications device such as a cell phone or a personal digital assistant (“PDA”).

In one embodiment, e-commerce 340 providers can have a secure web site where gaming cards can be ordered and activated. In such an on-line embodiment, a consumer may order the prepaid gaming card for delivery by mail. Upon receiving the card, the consumer can then return to the e-commerce 340 provider to activate the card or activate the card through one of the various gaming sites 310. Additionally, the consumer may receive the card number and PIN number via electronic communication (e.g. email) immediately after ordering the card from the e-commerce 340 provider. The consumer may then activate the card immediately, although this may be unwise for security purposes.

As illustrated, each of the providers and gaming sites are communicatively linked to the central server 300 over the network 360. Advantageously, this allows the providers and gaming sites to send an activation request to the central server over the network 300. Additionally, it allows the providers and gaming sites to receive an activation confirmation from the central server 300. Furthermore, it allows the gaming sites 310 to provide updated balance information to the central server, which then may control distribution of funds back to the consumer 350 through a retailer 320 or a financial institution 330.

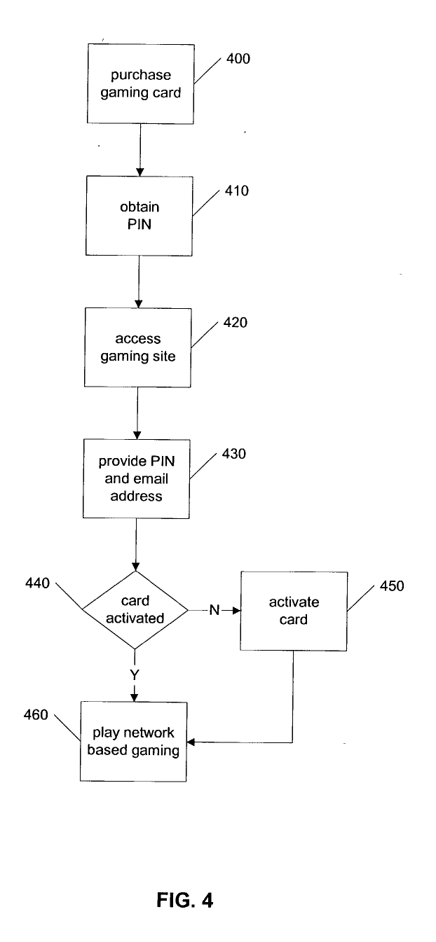

FIG. 4 is a flow diagram illustrating an example process for using a prepaid gaming card according to an embodiment of the present invention. Initially, instep 400, a consumer purchases the card. The card may be purchased at a variety of locations, including department stores, financial institutions, over the phone, over a network (e.g. via a web interface), and through a catalogue, just to name a few. Once the card is purchased, the consumer obtains the PIN, as shown in step 410. The PIN can advantageously be integrated with the packaging of the card or the PIN may be included on the card itself. For example, the PIN may be printed on the card underneath an opaque covering that can be scratched off to reveal the PIN, much like a lottery card can be scratched.

After the PIN has been obtained, the consumer can access a gaming site that is available over a network connection such as the internet, as illustrated in step 420. Once the consumer is interacting with the gaming site, the consumer can provide the PIN and an email address to the gaming site in order to be authenticated. Advantageously, the gamine sites can use a combination of information such as an email address and the PIN to authenticate a consumer. This allows consumers to remain anonymous if they choose to do so.

One the PIN and email address (or other authentication information) has been provided to the gaming site, the gaming site checks to see if the gaming card has been activated, as shown in step 440. If the card has not yet been activated, the gaming site carries out the process to activate the card. If the card is already active, the gaming site allows the consumer to commence gaming activities.

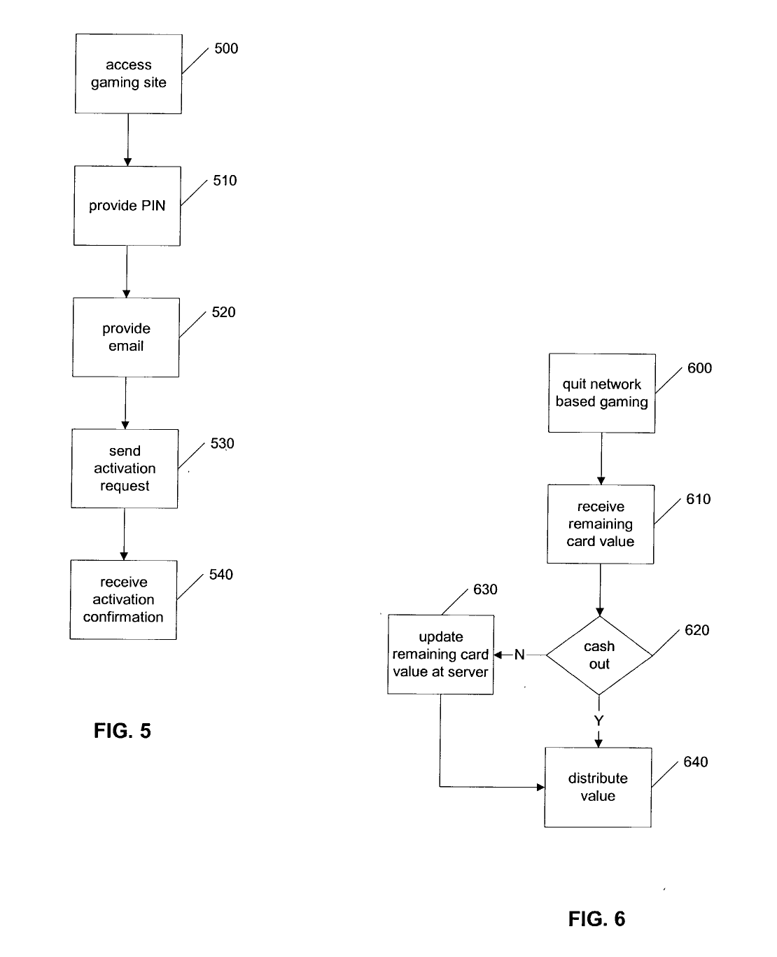

FIG. 5 is a flow diagram illustrating an example process for activating a prepaid gaming card according to an embodiment of the present invention. First, the consumer begins the activation process by accessing a gaming site in step 500. Preferably, the gaming site is available over a communications network, for example, the internet Alternatively, activation kiosks may be available in retail outlets or other locations that allow the consumer to swipe the prepaid gaming card and enter information via a keyboard or other input device.

The consumer next provides the gaming site with the PIN from the gaming card in step 510 and some authorization information in step 520. For example, the authorization information provided by the consumer may be an email address, a social security number, a tax identification number, a driver's license number, or a credit card number, just to name a few. An advantage of using an email address for the authentication information is that it provides increased anonymity to the consumer.

Once the authorization information has been provided, the gaming site sends an activation request in step 530 to a central activation server that collects the information and provides the gaming site with an activation confirmation, which is received in step 540. In one embodiment, the activation confirmation can include the amount of funds available on the gaming card. Additionally, if the central activation server is able to locate a profile for the consumer (e.g. by a database lookup using a social security number or other unique identifier), the activation confirmation can include gaming preferences for the consumer that allows the gaming site to tailor its presentation of gaming options and information to the consumer.

FIG. 6 is a flow diagram illustrating an example process for cashing out a prepaid gaming card according to an embodiment of the present invention. Initially, in step 600, the consumer quits the network based gaming session. At this point, the consumer preferably has funds remaining on the balance of the prepaid gaming card. If no funds are remaining, then the cashing out process would not be available. In one embodiment, however, a gaming site may provide a minimum cash out balance on a prepaid gaming card as a discount or refund to encourage the consumer to keep the card and perhaps pay to add funds to the card at a later date.

In step 610, the consumer is notified of the remaining value of the card. This notification can be presented in a special window, via an email, or directly within the network based gaming application. In step 620, the consumer is presented with an option to cash out the value of the card. If the consumer decides not to cash out the card, in step 630 the central server is updated with the remaining balance on the card so that future sessions will provide the consumer with the correct amount of funds.

If the consumer elects to cash out the value of the card, in step 640 the funds are distributed. Distribution of the funds can be carried out in a variety of ways. For example, funds can be distributed by sending a check to the consumer or by an electronic funds transfer of the balance to the bank account of the consumer. Alternatively, the funds can be distributed by updating a distribution database that allows a consumer to present the gaming card at a retail outlet where the card is swiped an authenticated and then the distribution value is provided by the central server or a separate distribution server. Once the retail outlet receives the distribution amount, cash can be given to the consumer. In one embodiment, a maximum value limit may be placed on the retail distribution option so that retail stores are not asked to cash out large balances that may have an adverse affect on their in-store cash supply.

At this point, a complete description of an example consumer using a prepaid gaming card may be helpful. Initially, a consumer purchases a prepaid gaming card in a retail outlet. The consumer may also purchase the prepaid gaming card through other means. Once in possession of the prepaid gaming card, the consumer can access a prepaid gaming site. Access by the consumer can be via a personal computer with a network connection, through a terminal kiosk, through a wireless communication device with a data connection to a communications network, or through other means. Preferably, each method of access by the consumer allows the consumer to interact with a gaming server and an authentication server, which can be integrated within a single computer or implemented on separate, discrete servers.

Once the consumer purchases the prepaid gaming card, the consumer obtains the PIN number for the card. This may be done by scratching off an opaque covering to reveal the PIN or by opening the packaging of the card to reveal the PIN. Alternatively, the consumer may be required to call a service number or access a service web site to obtain the PIN, perhaps by providing certain information. Once the consumer has the PIN, the consumer can access network based gaming sites to begin playing.

The network based gaming sites can preferably be accessed via a network enabled computing device (personal computer, cell phone, PDA, etc.) using a standard browser application or other HTML, XML, SGML, etc. web enabled utility. Once the consumer accesses a network based gaming site, the consumer provides the PIN for the prepaid gaming card and some authorization information. The authorization information is preferably non-intrusive such as an email address, but it may also include personal information or information unique to a particular individual such as a social security number.

Once the consumer has provide the network gaming site with the PIN and authorization information, the gaming site checks with a centralized server to validate the consumer and the prepaid gaming card. If the card has been activated and the authorization information is correctly associated with the PIN, the centralized server provides the gaming site with the current value of the card so that gaming may begin. The server may also provide additional information to the gaming site, such as consumer preferences for games, amounts typically played, and other security related metrics, information and marketing related metrics and information.

If the card has not been activated, then the central server takes the PIN and the authorization information and activates the card. Once the card has been activated, the central server provides the gaming site with the current value of the card and any stored profile information for the consumer. For example, if the authorization information consists of a social security number, the central server may look up the consumer profile for that social security number and then provide the gaming site with marketing and security related demographics for the particular consumer.

After the gaming site has the current value of the card and any information about the consumer the gaming allows the consumer to play the games offered by the site. At the end of the consumer's gaming session, the consumer may have increased or decreased the total amount available on the prepaid gaming card. In the case where the total amount has been decreased, the gaming site may initiate an ACH or EFT transaction to transfer funds from the centralized server (or other account storing the funds used to purchase the prepaid gaming card). Payment of funds to the gaming site may be handled on an individual session basis or on a cumulative monthly or quarterly basis, depending on factors such as efficiency and cost of transferring funds.

When the consumer still has funds available at the end of a session, the consumer may choose to cash out those funds. The funds can be delivered to the consumer in a variety of ways, including EFT to the consumer's bank account or ACH to the consumer's bank account. The funds may also be delivered to the consumer via a paper check that is mailed to the consumer's address by a financial institution or by the state or federal gaming commission, etc. Alternatively, the value of the prepaid gaming card may be updated to reflect the current amount available on the card for future sessions. The consumer may then elect to visit a retail outlet and cash out the card. In such a case, the retail outlet preferably has a network access device that authorizes the card using the PIN and the consumer authorization information. The authorization then allows the centralized server to provide the retailer with the current value information so that the consumer may be paid the current value on the card. In one embodiment, the retail outlet may charge a fee for cashing out, which may be a flat fee or a percentage of the total value of the card.

It is understood that the description and drawings presented herein represent presently preferred embodiments of the invention and are therefore representative of the subject matter which is broadly contemplated by the present invention. Thus, the scope of the present invention fully encompasses other embodiments and is accordingly limited by nothing other than the appended claims.

What is claimed is:

1. A system for providing network based gaming services, the system comprising:
a prepaid gaming card having an identification number and a current dollar value;
a gaming server communicatively coupled with a communications network, the gaming server configured to provide gaming services over the communications network;
an authentication server communicatively coupled with the communications network, the authentication server configured to authenticate the prepaid gaming card, wherein a consumer provides the identification number to the authentication server and the authentication server authenticates the prepaid gaming card and provides the current value to the gaming server.

2. The system of claim 1, wherein a single server computer comprises the gaming server and the authentication server.

3. The system of claim 1, wherein the communication network comprises the internet.

4. The system of claim 1, wherein the communication network comprises a wireless communication network.

5. A method for providing network based gaming services, the method comprising:
receiving an authorization request, the authorization request comprising a card identification number and a consumer identification information;
consulting a database comprising a plurality of card records, each card record containing a card identification number and a corresponding dollar amount;
retrieving a card record from the database, the card record having the card identification number received with the authorization request; and
providing an activation confirmation comprising the corresponding dollar amount from the database record.

6. The method of claim 5, wherein the consumer identification information comprises a unique consumer identifier.

7. The method of claim 6, wherein the database further comprises a plurality of consumer records, each consumer record having a unique consumer identifier and a consumer profile, the method further comprising:
retrieving a consumer database record having the unique consumer identifier; and
providing an activation confirmation comprising the consumer profile from the consumer database record.

8. The method of claim 5, wherein the authorization request is received via a communications network.

9. A method for cashing out a prepaid gaming card, the method comprising:
receiving from a requesting consumer a cash out request, the cash out request comprising a card identifier and a new dollar value;
consulting a database comprising a plurality of card records, each card record containing a card identifier and a corresponding dollar amount;
retrieving a card record from the database, the card record having the card identifier received with the cash out request;
updating the corresponding dollar amount with the new dollar value; and
providing the requesting consumer with funds equal to the new dollar value.

10. The method of claim 9, wherein the providing step further comprises sending a check to the requesting consumer.

11. The method of claim 9, wherein the providing step further comprises giving the requesting consumer cash equal to the new dollar value at a retail outlet.

12. The method of claim 9, wherein the providing step further comprises electronically transferring funds into the requesting consumers bank account.

13. The method of claim 12, wherein the electronic transfer is an automated clearing house (ACH) transaction.

14. The method of claim 12, wherein the electronic transfer is an electronic funds transfer (EFT) transaction.

15. The method of claim 12, wherein the electronic transfer is a wire transfer transaction.
